(19) United States
(12) Patent Application Publication
(10) Pub. No.: US 2006/0052943 A1
(43) Pub. Date: Mar. 9, 2006

(54) Architectures, queries, data stores, and interfaces for proteins and drug molecules

(76) Inventors: Karthik Ramani, West Lafayette, IN (US); Srinivasan S. Turuvekere, Rochester, NY (US); Manish Agrawal, Bangalore (IN)

Correspondence Address: Schwegman, Lundberg, Woessner & Kluth, P.A., P.O. Box 2938, Minneapolis, MN, 55402, US

(21) Appl. No.: 11/191,401

(22) Filed: Jul. 28, 2005

Related U.S. Application Data
(60) Provisional application No. 60/591,702, filed on Jul. 28, 2004.

(51) Int. Cl. G06F 19/00

(52) U.S. Cl. 702/19

(57) ABSTRACT

Architectures, queries, data stores, and interfaces for proteins and drug molecules are provided. Active and binding sites or proteins and drug molecules are modeled and indexed in a data store. The data store may be browsed, searched, and mined to find specific proteins or to find potential drug molecules that interact with the proteins in response to the active and binding sites.

### RELATED APPLICATION

This non-provisional application claims the benefit of U.S. Provisional Application Ser. No. 60/591,702 filed Jul. 28, 2004, titled: “Architecture and Description for a Geometric Query Engine for Proteins and Drug Molecules”, the disclosure of which is incorporated by reference herein.

### FIELD

The invention relates generally to data modeling and search and retrieval, and more particularly to protein modeling and search and retrieval.

### BACKGROUND

Over the past decade, substantial research has been done in the area of bio-informatics, computational molecular biology and data-mining. People have in the past focused on the development of systems for structural comparison and alignment of proteins and compounds. But most of these systems have a pre-determined notion of similarity implemented as a part of their algorithm. Also, in the past decade, many different research groups have attacked the problem of protein-protein docking and protein-ligand docking. Most of these efforts can be broadly classified into two main groups: geometric complementarily based and energy based. Research has shown that the use geometric complementarily followed by energy based refinement produces the best results. The popular prototypes of docking engines focus mainly on the pair-wise docking problem and are computationally very intensive, thus requiring huge computational setup and are far from the ideal real-time docking engines.

Life is based on molecular interactions. Underlying every biological process is a multitude of proteins, nucleic acids, carbohydrates, hormones, lipids, and cofactors, binding to and modifying each other, forming complex frameworks and assemblies, and catalyzing reactions. Hence, molecular interactions play a very crucial role during the drug-discovery process. In 2002, UBS Warburg in their life sciences market study has estimated that a drug discovery company spends between 8-12 years and approximately $500 million in the development of a new drug. Moreover, an average prescription drug generates about $400 million over its lifetime. Thus, the productivity of drug discovery process needs to be improved. The broad needs of the drug discovery market and some statistics supporting those needs are as follows:

Need to expedite the discovery process: It takes around 6 years in the discovery phase of drug development that includes target identification, target validation, synthesis, screening, and optimization, with an average cost of $250 million, 50% of the total cost.

Need for more successful clinical trials: It is estimated that an average pharmaceutical company spends about 50% of its R&D expenses on clinical trials and 90% of the drugs entering clinical trials phase fail to reach the market.

Need to manage the ever-growing data repositories: The genomic and proteomic data is doubling every 12 months. The total number of possible molecules satisfying the molecular weight criteria is 10200 of which 1050 might possess drug like properties.

### SUMMARY

In various embodiments, data modeling and search and retrieval for proteins, receptor sites of proteins, ligands, and drug molecules are provided. More particularly and in an embodiment, an active site or binding site of a protein is indexed in response to a histogram and that active or binding site's distance to other features of a protein. The indexed active or binding site provides an electronic characterization of the active or binding site as a trough or peak on the surface of the protein.

### BRIEF DESCRIPTION OF THE DRAWINGS

FIG. 1 is an architectural diagram of BioQ according to an example embodiment.

FIG. 2 is a diagram of a data structure for a protein class hierarchy, according to an example embodiment.

FIG. 3 is a diagram of a feature vector and algorithm class data structures, according to an example embodiment.

FIG. 4 is a diagram of a visibility map for a 3×3×3 matrix, according to an example embodiment.

FIG. 5 is a diagram representing results of a Bresenham algorithm, according to an example embodiment of the invention.

FIG. 6 is a diagram graphically representing the results of a Bresenham algorithm in three dimensions, according to an example embodiment.

FIG. 7 is a diagram graphically representing how the visibility of direction is calculated, according to an example embodiment.

FIG. 8 is a diagram graphically representing a technique for obtaining hash table entries, according to an example embodiment.

FIG. 9 is a diagram graphically representing the hash table locations, according to an example embodiment.

FIG. 10 is a diagram of a flowchart for a method of registering an object component and a geometric hashing and indexing technique, according to an example embodiment.

FIG. 11 is a diagram of a flowchart for a method of searching and recognizing object components that are indexed according to FIG. 10, according to an example embodiment.

FIG. 12 is diagram graphically representing a scoring scheme, according to an example embodiment.

FIG. 13 is a diagram graphically representing a modified scoring scheme, according to an example embodiment.

FIG. 14 is a diagram graphically representing an oct-tree based adaptive sub-division for non-uniform distribution of indices, according to an example embodiment.

### DETAILED DESCRIPTION

Embodiments of the invention are referred to as BioQ. BioQ has many different modules and one notable module is BioQuery. BioQuery is a query based module that supports various types of geometric queries. The following section provides a brief description of the features and technologies that form the basis for BioQ.

Features: A brief description of various modules and their corresponding features is given below:

BioQuery: Rational drug design process can be defined as using structural information about drug targets or their natural ligands as a basis for the design of effective drugs. In simple words, the drug molecule/ligand must have a complementary geometry to the intended active site to dock with the target protein. This problem is complicated by the fact that a drug molecule is “flexible” and can achieve many low-energy (stable) states. Hence, the structure and 3D geometry play an important role in the design of new drugs. The query features are classified into two main groups:

### Docking, Structure and Geometry Related Queries

Automated Active site identification: Given the structure of the receptor, this feature automatically determines the potential active sites in the target/receptor and rank them based on their relative sizes.

Automated Binding site identification: Given the structure of a ligand, this feature automatically determines the potential active sites in the ligand and rank them based on their relative sizes.

Automated Docking and visualization: Given a receptor and a ligand, this feature helps predict the 3D structure of the possible complexes and rank them based on their docking scores.

Screening molecules based on docking score and specificity: Given a receptor this tool scans a combinatorial library for potential candidates and order them based on their docking scores.

Other miscellaneous queries: Apart from the above docking related queries, the tool also supports other useful geometric queries such as queries related to dimer interfaces, internal & edge strands, core, biological pathways, etc.

### Basic Textual Queries

Query for targets containing specific residues at specific locations: All queries related to secondary structure, residue, primary sequence, and atom information.

Query for annotations of proteins in PDB: All kinds of queries based on the information contained in the PDB file including annotations.

BioVisualization: It has wisely been said “A picture is equivalent to thousand words”. One of the biggest issues with most IT tools for drug industry is that most of the researchers and biologists are not techno savvy, hence if the user interface is not intuitive there is threat it might result in the failure of the tool.

3D visualization interface: This tool allows users to display the compounds and other data in an intuitive visualization interface.

Intelligent query interface: This tool allows users to compose different queries and display the results of these queries.

Knowledge based navigation interface: This tool allows users to visualize the various clusters and zoom into individual clusters.

BioSearch: Pharmaceutical drug design is a long and expensive process. Early selection of promising molecules can dramatically improve this process, but this selection is often similar to searching for a needle in a haystack. Hence, efficient structure based similarity search tools have large benefits for the drug discovery market.

Search for matching proteins or structures: This feature allows users to search for compounds and proteins having similar structure a query compound.

Search for targets or molecules with matching substructures: This feature determines similar sub-structures between a set of compounds. Many a times, a chemist initially has a small collection of molecules that exhibit enough desired activity to hypothesize that they share a 3-D substructure binding to the same receptor site. With BioSearch, the chemist can identify this sub-structure. This can then be used as a pattern to screen databases of molecules.

Search for proteins in a particular family: This feature allows researchers to search for evolutionarily related proteins.

Search for molecules having similar binding sites and active sites: This feature allows researchers to screen a database of compounds that have active or binding sites similar to the query molecule.

BioCluster: The most intuitive way of browsing through a large database of structures and compounds is to cluster the entire database into related groups. BioCluster module is intended to serve this purpose. This module allows users to hierarchically cluster molecules based on different criteria such as family, structure, shape of sites etc.

Technology: The unique features of BioQ have been made possible through its strong technological base. BioQ is developed using a flexible and scalable 3-tier architecture), wherein the database, business logic and the application layers are separated into three different tiers. This architecture facilitates maintainability and modularity of the supported features. Some of the notable technologies are listed as below:

The fully automated docking query tool is made possible through an indigenously developed voxelization-based feature recognition technique. Voxels are 3D equivalent of 2D pixels that captures the local geometric and structural information more accurately than any other statistical or mathematical technique and also supports easy manipulation of local geometry.

The flexible and intelligent object oriented class framework forms the part of the middle business logic layer and captures all the relevant information for answering different types of queries and provides interfaces for plugging in algorithms to answer new types of queries.

Model View Controller (MVC) pattern, zoomable interfaces, Open GL, VTK and Microsoft Foundation Classes (MFC) form the technological base for the BioVisualization module, which forms the part of the topmost application layer and allows different views on the underlying data.

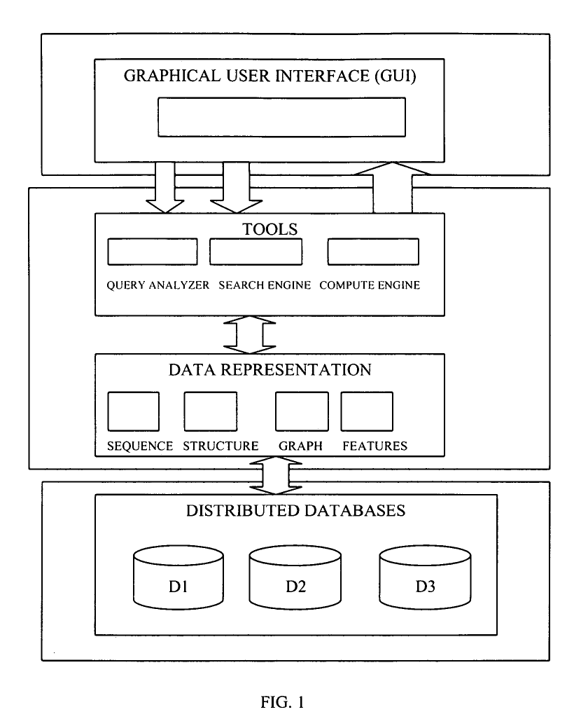

FIG. 1 is an architectural diagram of BioQ according to an example embodiment. The architecture is implemented in one or more machines as one or more software services in machine-accessible media. Moreover, the architecture is accessible over a network, and the network may be wired, wireless, or a combination of wired and wireless.

The database for BioQ contains various tables that store all the information required for supporting the various functionalities described above, e.g. information about proteins/classes. The information in the BioQ's database may be derived from many different distributed databases. For mapping the information from distributed databases to BioQ's database, one can use any data migration or equivalent tool. Currently, the BioQ's database supports mapping for storing all the required information derived from protein (PDB) files. Above the database layer, there is a layer of database classes, which provide functionalities for updating and extracting information from various database tables. This database class layer masks the supported functionalities from minor changes in the database schema. Above the database class layer, there is a flexible class hierarchy to represent only the required information from the database. This layer is necessary for two main reasons. Firstly, having a proper object-oriented class organization can enhance the functionalities provided and can also support multi-level implementation of various functionalities like similarity search etc. Secondly, the implementation of memory intensive functionalities becomes feasible, since the required information is only stored from the database. Since, many different features are supported by the system; having more than one form of representation for underlying information is inevitable. For instance, one may represent protein information in the form of a structure, graph, sequence or feature vectors. The tools layer contains various algorithms that operate on the information from the data representation layer and support the different functionalities. Finally, the GUI layer provides an intuitive user interface to display results and to gather input from the user.

### Data Structure

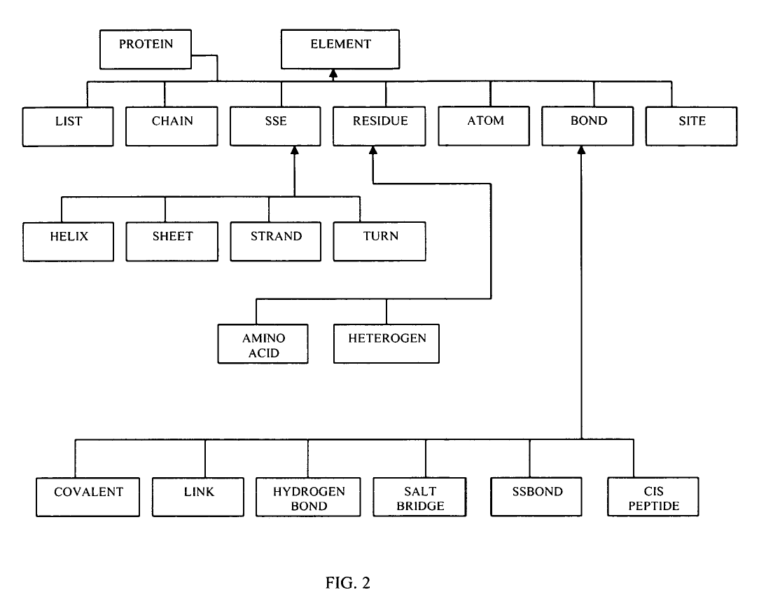

FIG. 2 is diagram of a data structure for a protein class hierarchy, according to an example embodiment. The data structure is implemented in a machine-accessible and computer-readable medium.

The information about a protein is contained in a protein data base (pdb) file and can be represented in different forms based on the needs of the system. FIG. 2 demonstrates the class hierarchy for representing the protein information. The represented class hierarchy is used by the similarity search module and by many other query functionalities that is not computationally intensive. For representing the docking related queries, there is a reduced representation that contains only the requisite information to optimize the memory requirements.

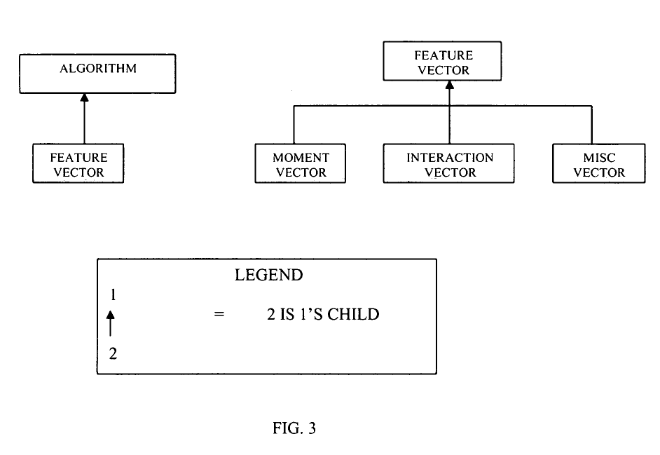

FIG. 3 is a diagram of a feature vector and algorithm class data structures, according to an example embodiment. FIG. 3 is presented for purposes of illustration and it is pointed out that other arrangements and configurations are possible without departing from the teachings presented herein.

Some of the important methods and member variables have been described below.

Element (This class is an abstract class)

Member Variables:

| Name | Description |
|---|---|
| elementtype | The type of element. The elementtype is a enum that |
| elementType | takes only certain values. |
| ElementNode * | This is the pointer to the node in a list to which this |
| elementNode | element belongs |

Member functions:

| Name | Description |
|---|---|
| virtual ˜Element( ) | The destructor has been declared as abstract and is |
| | implemented by its child classes. The element class |
| | has no constructor. |
| virtual int | This function compares an element to the current |
| compare(void *); | element and determines if it is equal, less than or |
| | greater than the current element. Since the function |
| | is declared as virual(abstract), all child classes of |
| | Element class are required to implement the |
| | compare method, such that the method |
| | returns 0 if they are equal, 1 if the |
| | passed element is greater than the |
| | current element and −1 otherwise. |

ElementNodes

Member Variables:

| Name | Description |
|---|---|
| ElementNode * | This variable stores the pointer to the previous node |
| previousNode | in a doubly linked list. |
| Element * | This variable stores the pointer to the element stored |
| currentElement | at the current node. |
| ElementNode * | This variable stores the pointer to the next node in a |
| nextNode | doubly linked list. |

Key Member functions:

| Name | Description |
|---|---|
| virtual int | This function compares two ElementNodes for |
| compare(void *); | equality and returns 0 if they are found equal. |

List (It is a Child Class of Element Class)

Member Variables:

| Name | Description |
|---|---|
| ElementNode * | This is the pointer to the ElementNode at the head of |
| head | the List. |
| ElementNode * | This is the pointer to the ElementNode at the tail of |
| tail | the List. |
| ElementNode * | This is the pointer to the ElementNode position in |
| iterator | the list when the List is being iterated. |
| int count | This variable keeps the count of the number of |
| | elements in the List. |

Key Member Functions:

| Name | Description |
|---|---|
| Element * findElement(Element *) | This function iterates through the List to find an |
| | element that has a key similar to the key of the |
| | element passed as an argument to the function. The |
| | function returns Null if it fails to find the element in |
| | the List. |
| void addElement(Element *) | This function inserts the element that has been |
| | passed as argument to the function. The compare |
| | function of the Element is used to determine the |
| | position of the element in the List. |
| Element * | This function iterates through the List to find an |
| removeElement(Element *) | element that has a key similar to the key of the |
| | element passed as an argument to the function. Once |
| | the element is found, the Element and its |
| | corresponding nodes are removed from the List and |
| | the pointer to the removed element is returned to the |
| | user. The function returns Null if it fails to find the |
| | element in the List. |
| int compare(void *) | If the two Lists are compatible, then the Heads of |
| | the two lists are compared. (Since, the elements are |
| | arranged in an ascending order within a list). |

Protein (Child Class of the Class Protein)

Member Variables:

| Name | Description |
|---|---|
| char * pdbId | This variable stores the pdbID as a string. |
| List * chainList | This variable stores the List of chains in protein |
| List * heterogenList | This is a List of Het groups in the protein. |
| List * sheetList | This is the pointer to the sheetList in the protein, |
| | usually the Chain class contains the List of |
| | secondary structures, but sheets can contain strands |
| | from more than one chain. |
| Char * | This string classifies the molecule. |
| classification; | |
| int noOfHelices | The number of helices in the protein. |
| int noOfStrands | The number of Strands in the protein. |
| int noOfTurns | The number of Turns in the protein. |
| int noOfHets | The number of Het Groups in the protein. |
| int | The number of Components (chains and het groups) |
| noOfComponents | in the protein. |
| int noOfResidues | The number of Residues in the protein. |
| int noOfBonds | The number of Bonds in the protein. |
| int noOfAtoms | The number of Atoms in the protein. |
| int noOfSites | The number of Active Sites in the protein. |
| int noOfCaAtoms | The number of Ca Atoms in the protein. |

Key Member Functions:

| Name | Description |
|---|---|
| void addChain(Chain *) | This function adds a new chain to the |
| | List of Chains in the Protein. |
| bool removeChain(Chain *) | This function removes a chain from |
| | the List of Chains in the Protein. |
| Chain * findChain(Chain *) | This function finds a chain from |
| | the List of Chains in the Protein. |
| matrix * getDistanceMatrix( ) | This function computes and returns |
| | the distance matrix for the whole protein. |
| matrix * getAngleMatrix( ) | This function computes and returns |
| | the Angle matrix for the whole protein. |
| matrix * | This function returns a matrix |
| getAtomCoordinates( ) | containing the coordinates of all the |
| | atoms in the whole protein. |
| int compare(void *) | The function compares two proteins. |
| | The two proteins are compared |
| | using their pdbIDs. |

Chain (Child Class of the Class Element)

Member Variables:

| Name | Description |
|---|---|
| char chainId | The character stores the unique chain ID. |
| List * residueList | This variable stores the List of residues |
| | in the chain. |
| List * SSEList | This is a List of Secondary Structure |
| | Elements in the protein. |
| Protein * parentProtein | Reference to the protein to which |
| | this chain belongs to. |

Key Member Functions:

| Name | Description |
|---|---|
| matrix * | This function computes and returns the distance |
| getDistanceMatrix( ) | matrix for the chain. |
| matrix * | This function computes and returns the Angle |
| getAngleMatrix( ) | matrix for the chain. |
| matrix * | This function returns a matrix containing the |
| getAtomCoordinates( ) | coordinates of all the atoms in the chain. |
| int compare(void *) | The function compares two chains. The two |
| | chains are considered equal if they have the |
| | same pdbID and chainID. |

Family

Member Variables:

| Name | Description |
|---|---|
| char * familyName | The string stores the name of the family. |
| List * proteinList | This variable stores the List of proteins in |
| | the current family. |

Key Member Functions:

| Name | Description |
|---|---|
| void addProtein(Protein *) | This function adds a protein to |
| | the current family. |
| bool removeProtein(Protein *) | Removes the protein from |
| | the current Family. |
| Protein * findProtein(Protein *) | Finds the protein from the family. |
| int compare(void *) | The function compares two families |
| | using their name. |

SecondaryStructure (It is a Abstract Class and is a Child of the Element Class)

Member Variables:

| Name | Description |
|---|---|
| Chain * parentChain | The pointer to the parent Chain to which the current |
| | secondary structure belongs. |
| ssetype SSEType | Type of Secondary Structure. The elementtype is an |
| | enum that takes only certain values. |

Key Member Functions:

| Name | Description |
|---|---|
| virtual | The destructor of the class Secondary |
| ˜SecondaryStructure( ) | Structure has been declared as abstract. |
| Virtual matrix * | The function returns the matrix containing the |
| getAtomCoordinates( ) | coordinates of all the atoms in the Secondary |
| | structure. The function is declared abstract, |
| | hence it has to be implemented by |
| | all its child classes. |
| int compare(void *) | The function compares two secondary |
| | structures and is declared as abstract. |

Helix (A Child Class of the Secondary Structure Class)

Member Variables:

| Name | Description |
|---|---|
| int helixNum | The variable stores the unique helix number of the |
| | current helix. |
| Residue * initResidue | The pointer to the starting residue on the primary |
| | structure, where helix starts. |
| Residue * endResidue | The pointer to the ending residue on the primary |
| | structure, where helix starts. |
| char * comments | The string that stores the comments associated |
| | with this helix deposited in the pdb file. |
| int helixClass | The class of the current Helix. |
| int length | The length in number of residues of the |
| | current helix. |

Key Member Functions:

| Name | Description |
|---|---|
| matrix * getAtomCoordinates( ) | The function returns the matrix |
| | containing the coordinates of all the |
| | atoms in the helix. |
| int compare(void *) | The function compares two helices |
| | using the unique helixID or |
| | helix number. |

Strand (A Child Class of the Secondary Structure Class)

Member Variables:

| Name | Description |
|---|---|
| int strandNum | The variable stores the unique strand |
| | number of the current strand. |
| Residue * initResidue | The pointer to the starting residue on the primary |
| | structure, where strand starts. |
| Residue * endResidue | The pointer to the ending residue on the primary |
| | structure, where strand starts. |
| int length | The length in number of residues of the current |
| | Strand. |
| int sense | The variable determines if the strand is in the |
| | parallel or anti-parallel orientation in the sheet. |
| | A value of 1 indicates parallel orientation and a |
| | value of −1 indicates anti-parallel orientation. |

Key Member Functions:

| Name | Description |
|---|---|
| matrix * getAtomCoordinates( ) | The function returns the matrix |
| | containing the coordinates of all the |
| | atoms in the strand. |
| int compare(void *) | The function compares two strands |
| | using the unique strandID or |
| | strand number. |

Sheet (A Child Class of the Secondary Structure Class)

Member Variables:

| Name | Description |
|---|---|
| char * sheetID | The unique identifier for the current sheet. |
| Residue * initResidue | The pointer to the starting residue on the primary |
| | structure, where strand starts. |
| Residue * endResidue | The pointer to the ending residue on the primary |
| | structure, where strand starts. |

Key Member Functions:

| Name | Description |
|---|---|
| matrix * getAtomCoordinates( ) | The function returns the matrix |
| | containing the coordinates of all the |
| | atoms in the sheet. |
| int compare(void *) | The function compares two strands |
| | using the unique sheetID |

Turn (A Child Class of the Secondary Structure Class)

Member Variables:

| Name | Description |
|---|---|
| char * TurnID | The unique identifier for this Turn/Loop. |
| Residue * initResidue | The pointer to the starting residue on the primary |
| | structure, where Turn/Loop starts. |
| Residue * endResidue | The pointer to the ending residue on the primary |
| | structure, where Turn/Loop starts. |
| int length | The length in number of residues of the current |
| | Turn/Loop. |
| Char * comments | The string contains the comments for the current |
| | Turn/Loop deposited in the pdb file. |

Key Member Functions:

| Name | Description |
|---|---|
| matrix * getAtomCoordinates( ) | The function returns the matrix |
| | containing the coordinates of all the |
| | atoms in the Turn/Loop. |
| int compare(void *) | The function compares two strands |
| | using the unique turnNum |

ActiveSite (Is a Child of the Secondary Structure Class)

Member Variables:

| Name | Description |
|---|---|
| int numRes | The number of residues forming the site. |
| Residue ** residueArray | An array of pointers to the residue that form the |
| | Active Site. |
| int resIndex | This variable keeps the count of number |
| | residues present in the residueArray. Note |
| | resIndex <= numRes. |
| Char * siteID | The unique string identifier for the site. |

Key Member Functions:

| Name | Description |
|---|---|
| matrix * getAtomCoordinates( ) | The function returns the matrix |
| | containing the coordinates of all the |
| | atoms in the active Site. |
| matrix * getDistanceMatrix( ) | This function forms and returns the |
| | distance matrix using the residues |
| | of the site. |
| int compare(void *) | The function compares two sites |
| | using their unique siteIDs. |

Bond (A Abstract Child Class of the Element Class)

Member Variables:

| Name | Description |
|---|---|
| bondtype bondType | The variable is of type enum that takes only |
| | a fixed set of values |
| Element * firstElement | The pointer to the first element that takes |
| | part in the bond formation. |
| Element * secondElement | The pointer to the second element that |
| | takes part in the bond formation. |

Key Member Functions:

| Name | Description |
|---|---|
| virtual ˜Bond( ) | Virtual destructor, to be implemented by its |
| | child classes. |
| virtual int compare(void *) | The function has been declared virtual so |
| | that it can be implemented by its child |
| | classes |

### Site Identification

Defined below are some of the relevant terms and definition.
a) Voxel: A three-dimensional equivalent of a pixel. Alternatively, it can be also described as a small cube of volume in the 3-D space.
b) Voxel Visibility or degree of exposure: It is a metric for measuring the visibility exposure of a voxel.

$$Degree of exposure = \frac{Visibility map area in the unit sphere}{Total unit surface area}$$
c) Filled Voxel: It is a voxel that is within a certain threshold distance from any atom in the protein. (Refer to section on voxelization)
d) Cavity Voxel: An empty or unfilled voxel after discretization.
e) Internal Cavity Voxel: An empty voxel that meets the visibility criteria.
f) External Cavity Voxel: A cavity or empty voxel that is not an internal cavity voxel.
g) Surface Voxel: A filled voxel, which is adjacent to a cavity voxel and sharing at least a face with it.
h) Active Site Voxel: A surface voxel, which is adjacent to an internal cavity voxel.
i) Binding Site Voxel: A surface voxel, which is adjacent to an (inverted) internal cavity voxel.

### Voxelization

Defined below are some of the relevant terms and definition.

Voxels are 3d equivalents of 2d pixels. Voxelization is the process of converting 3D geometric objects from their continuous geometric representation into a set of voxels that best approximates the continuous object in a 3D discrete space. The 3D discrete space is a set of integral grid points in 3D Euclidean space defined by their Cartesian coordinates (x,y,z). A voxel is the unit cubic volume centered at the integral grid point. The voxel value is mapped into {0,1}: the voxels assigned “1” are called the “black” voxels representing opaque objects, and those assigned “0” are the “white” voxels representing the transparent background. Every voxel has 26 such adjacent voxels—eight share a vertex (corner) with the center voxel, twelve share an edge, and six share a face.

Conventional approaches for voxelization use a polygonal model, a parametric curve or an implicit surface as input. Scan filling or recursive subdivision algorithms are used for voxelization.

The approach used for voxelization is described here: a geometric model of the protein and ligand molecules are used, where Cartesian coordinates (x, y, z) are know for all atoms. The molecule is projected onto a three dimensional grid of size N×N×N, where N is diameter of a smallest sphere that can enclose the whole molecule structure with some offset distance. The size of each grid can be a user defined parameter, and it represents the resolution of voxel model. Each grid is labeled as either inside molecule or outside molecule. Any grid point is considered inside the molecule if there is at least one atom nucleus within a distance r from it, where r is half the average van der Waals atomic distance required for forming hydrogen bond. Alternative value for r could be van der Waals atomic radii.

Next step is to distinguish all voxels labeled as inside molecule (internal cavity) into surface voxel and internal cavity (non-surface molecule). Surface voxels are defined as voxels that lie at the boundary of inside and outside grid. All inside grid whose one of the 6 facial neighbor is outside the molecule is labeled as surface voxel.

### The Voxel Data-Structure

After a molecule is converted into grids, each grid should not only store whether it is inside or outside molecule, instead it is desired to store molecule properties so that no information is lost in discretization. Storing molecular property for each grid will help in accessing the local information. Data structure for voxel has been designed such that each voxel can store all the local information of the molecule. Extreme care has been taken in designing and optimizing the data structure so that it can handle large molecular structures and provide fast storage and retrieval. The attributes stored in the database are described below:
flags: this is char type and stores voxel property like it is inside molecule or outside molecule, cavity voxel, surface voxel, active site voxel. Each bit in the character is assigned for certain attribute and turned on and off depending on the property.
GID: this is int type and stores the group ID of cavity group.
blockedDirectionSize: this is char type and stores the number of invisible direction.
directionalVisibility: this is int type and stores the visibility along all possible discrete number of directions. Each bit in int is assigned to a direction and is turned on if the direction is visible. This saves a lot of space because just one variable is able to store visibility information for all directions.

Atom: this is pointer to class type Atom and the class Atom stores atom information of the nearest atom nuclei. Atom information include all the information that are there in PDB file under ATOM record and information about the residue to which this atom belongs that can extracted from a PDB file.

### Active/Binding Site Identification

The possible site of interaction between a protein molecule and a ligand molecule can primarily be classified as:

Active site, which are cavity or pocket region in protein or ligand molecule. Usually, the larger molecule has active site on it.

Binding site, which are protrusion or bump region in protein or ligand molecule. Molecules are relatively small and currently there is no other algorithm than can identify binding sites.

In the current invention, voxel visibility based method is used for identification of active site and binding site. Active sites are classified as cavity region on protein surface, while binding sites are classified as protrusions on the protein surface. One of the important properties of a cavity on any surface is used here. The property is: cavity region will have less visibility as compared to other part of surface. To measure the visibility of a surface, a calculated degree of visibility is determined. The degree of visibility can be defined using concept of solid angle. Solid angle is defined as, the angle that, seen from the center of a sphere, includes a given area on the surface of that sphere. The value of the solid angle is numerically equal to the size of that area divided by the square of the radius of the sphere, and is mathematically represented as: □=A/r2. If for a given point, all the visible directions are projected onto the unit sphere, the degree of visibility will be defined as:

$$Degree of visibility = \frac{visibility area in the unit sphere}{surface area of unit sphere}$$

If the point is visible in all possible direction, then visible area in the unit sphere will be equal to surface area of unit sphere, which is equal to 4π. Note that, 4π is the maximum solid angle.

For determining the visibility of a voxel, a concept of directional visibility is used. A voxel is said to be visible along certain direction, if a ray projected from the voxel in the direction doesn't hit any inside voxel. By calculating the total number of visible direction for a voxel, one can calculate the visible area in unit sphere, hence one can calculate the visibility of that voxel. However, there are infinite possible directions that need to be considered while calculating directional visibility, which is computationally impossible. To avoid this computational infeasibility, there is considered a discrete number of directions. It involves, dividing the total directional space into equally distributed finite number of visible directions. If there are n equally distributed finite directions and out of n there are m visible directions, then the degree of visibility will be m/n. The formula for degree of visibility can be redefined as:

$$\begin{matrix}Degree of visibility = \frac{visible area in the unit sphere}{surface area of unit sphere} \\ = \frac{number of visible directions}{total number of directions}\end{matrix}$$

Directional visibility of a voxel can be calculated using ray tracing algorithm. As mentioned above, a voxel is visible along the direction (i, j, k) if the ray (i, j, k) projected from the voxel, does not hit any inside voxel. Using this ray tracing method, directional visibility for all discrete direction is checked and degree of visibility of voxel is calculated. If the degree of visibility lies below certain threshold visibility value, the voxel is labeled as internal cavity voxel.

The following section describes the algorithm for identifying cavity and protrusion region in a molecule.

### Cavity Identification

In terms of visibility, cavities are the region with relatively low visibility as compared to other regions on the surface. The significance of identifying cavity is, it act as a site for interaction between two molecules. For the two molecules to interact with each other they should have shape complementarily, which is analogous to hand and glove fit. Steps involved in calculating cavity region are:

Step 1: Voxelize the protein or molecule. The atomic coordinate representation of molecule is converted into voxel model using the voxelization algorithm. Voxels that lie inside the molecule are labeled as inside and otherwise outside. Identify all the surface voxels.

Step 2: Visibility analysis is performed for all the voxels that are labeled as outside. If the visibility of voxel is below certain threshold, which is either predefined or can be set by user, the voxel is labeled as cavity voxel.

Step 3: The next step is to group all the cavity voxel so that they form a volume chunk which is filling-in the cavity surface region on molecule. The cavity voxels are grouped using grouping algorithm described later. The voxel groups are stored in a priority queue in descending order.

Step 4: Based on the input from the user, the top N groups from the priority queue is retained. Here, each group corresponds to one active site, so there will be total N active sites in molecule.

Step 5: Active site surface are identified from the N groups of cavity voxel selected in previous step. For this, identify all the surface voxel adjoining the group and label them as active site. For each active site voxel, identify all the neighboring voxel sharing the same residue and label them as active site, this is done using marching algorithm described later. During marching, if one hits a voxel from other group or active site, then the two sites are merged using merging algorithm. This makes sure that if two site are very close to each other in three dimensional space, then they are identified as one site.

Step 6: After merging, all the sites are sorted in descending order of their size or number of voxels.

### Protrusion Identification

This part of invention deals with identifying protrusions on the molecule surface. For the two molecules to interact with each other, shape of protrusion should be complimentary with the shape of cavity on the other molecule. Shape complementarities is the basic initial condition for the two molecules to interact, apart from this there are other factors like bio affinity, interaction energy, solvation etc. Taking an analogy from visibility definition of cavity, protrusions can be defined as surface having higher visibility as compared to any other region on the surface. However, identification of protrusion is not very trivial. If one simply uses the visibility criteria then there will lots of small regions satisfying the degree of visibility and hence will be identified as protrusion. On contrary, one is interested in identifying big protrusion region, which can be considered as a negative image of cavity, with inverted surface normal. This property is used, in identifying protrusions. All the steps involved in calculating protrusion surface are same as cavity identification with some additional steps for calculating the negative image, these are described below:

Step 1.1 Invert all the voxels, it means change all outside voxel as inside and vice versa except the surface voxel. Inverting voxels will produce negative image of voxel model and will help in identifying protrusions using the same algorithm as for cavity.

Step 1.2 Select a suitable visibility radius, for cavity identification the radius is by default infinity. By visibility radius, it is meant that the length of projected ray in the direction (i, j, k) for checking the directional visibility of voxel. In case of cavity identification it can be infinity because all the rays are going to hit the boundary of voxel and once it hit the boundary no further check is performed. However, since one has a negative image of voxel model all the rays are eventually going to hit inside voxel and hence resulting in zero visibility, thus limiting the direct use of visibility analysis. So, instead of having infinite radius some value is selected.

### Factors and Constants

While developing the described algorithm, various factors and constants affecting the efficiency of algorithm and the result as well have been identified. Some of these parameters are predefined and some can be changed by user. This section will talk about these parameters and their affect.

Voxel size: Similar to pixels, large voxel size will result in low resolution discrete structure of molecule. If the resolution is very low, some of the necessary details might be lost and is not good for site identification. However, low resolution helps is reducing noise as all small cavities, which are of no interest will be lost. On the other hand, if the resolution is very high, all the details will be preserved, but there will be more noise and more important, computational time will increase. Thus there should be a trade off between noise and computational time. After experimenting with different type of protein structure it is identified that, for cavity identification voxel size of 1 Armstrong and for protrusion identification voxel size of 0.9 Armstrong works well.

Distance(r): This is used for deciding weather a voxel is inside or outside molecule. If there is an at least one atom nucleus at a distance r from voxel then it is inside. There are many different ways to choose r value. It can be equal to radius of atom, in this case r will have different values depending on atom in consideration. Instead of having different r value, r can be equal to average van der Waals atomic radius. In the present case, r is chosen as half the value of average distance between two atomic centers required to form hydrogen bond between them.

Number of Sites: This parameter allows the user to decide how many active or binding site he wants to find out in a given molecule. The algorithm ranks the identified sites in descending order of their size and the top ‘n’ number of sites is produced as output.

Visibility Radius: Visibility radius is the length of projected ray in the direction (i, j, k) for checking the directional visibility of voxel. In case of cavity identification it can be infinity because all the rays are going to hit the boundary of voxel and once it hit the boundary no further check is performed. However, since there is a negative image of voxel model when finding protrusions, all the rays are eventually going to hit inside voxel and hence resulting in zero visibility, thus limiting the direct use of visibility analysis. So, instead of having infinite radius some value is selected. Based on testing done with different type of molecule, it is identified that 2.5 Armstrong works well for visibility radius.

Visibility Limits: This parameter helps in deciding whether a voxel is to be considered visible or invisible. If the number of blocked or invisible direction is between lower and upper visibility limit then the voxel is considered as invisible. The visibility can directly be translated into degree of visibility. Cavity regions are defined as regions with lower visibility, but since these are the region where other molecule will come and interact, they should not be totally invisible. In other words, they should have some minimum visibility and that is the reason that there is an upper and lower visibility limit. There is a predefined value of visibility limits, but the user is allowed to change this value based on his/her perception of visibility.

### Grouping:

A group refers to a connected chunk of similar voxels in space. The similarity of voxels refers to voxels belonging to the same category. Some of the categories of voxels are filled voxels, cavity voxels, internal cavity voxels, external cavity voxels, surface voxel, active site voxel, binding site voxel etc.

### Algorithm Overview

Given below are a few steps involved in the grouping of voxels:

(1) Start from the lowest voxel indices (0,0,0) and march in lexicographical order, i.e, Starting with z-direction, then y and then followed by x. Any lexicographical order can be selected.

(2) Select a seed voxel and march in all possible directions to find eligible neighboring voxels. Flag all the voxels, which have been marched. Currently, for any voxel, 26 neighboring voxels are considered. Of these 26 neighbors, 6 neighbors share a face with the current voxel, 8 voxels share a vertex with the current voxel and 12 voxels share an edge with the current voxel. The process is recursively repeated for each voxel being marched.

(3) Stop when there are no more neighboring voxels that meet the eligibility criteria. Assign a unique group ID to the current group. Depending on different proteins and the voxelization process, might have many different groups meeting a particular criterion.

(4) Continue marching in the pre-determined lexicographical order till another un-flagged seed voxel is reached. Repeat steps 2 & 3.

(5) Stop when no un-flagged seed voxel left.

### Algorithm Complexity

Since the algorithm starts off by identifying a seed voxel and then it marches neighboring voxels flagging all eligible voxels on its way. Once all neighbors meeting the eligibility criteria have been exhausted, the algorithm then looks for another seed voxel, which has not been already flagged. And since the identification of the seed voxel is done in lexicographical order, and each voxel is traversed at most twice. The determination of eligibility takes O(1) time, since the labeling of voxels is already done before the grouping algorithm. Hence, the grouping algorithm takes overall O(N3) time, where N is the dimension of the voxel grid. To illustrate, usually a large protein with 8 chains requires a grid of dimension 200 to store the voxel structure, with a span of 1.0 Angstrom per voxel.

### Storage Requirements

The algorithm uses the voxel grid created during the voxelization process (Refer to section 1). The storage requirement for the grouping algorithm is the eligibility flags stored per voxel and the group-id per voxel. Only a single byte is used to store all kinds of labels associated with each voxel. Also, after considerable testing, it is found that up-to four bytes are required to store all group-ids. Hence, there may be required an additional storage space of around 5 bytes per voxel. Also, note that one could have set the group-id as short data-type (two-bytes), but that would limit the number of groups formed to 65535. In generic terms, the storage complexity for the algorithm is O(N3).

### Discretized Marching in 3D

To calculate the Degree Of Exposure (DOE), a visible area in voxel-visibility map is necessary. However, collecting visible directions is not a simple issue. It is because a number of rays from the voxel are uncountable. In order to investigate infinite number of viewing directions with reasonable computing resources, the visibility map is divided into equally distributed sections and visibility from the center of each section to the voxel replaces visibility information of whole section. It means if the voxel is visible from the center of a section, the voxel is visible from any point in the section.

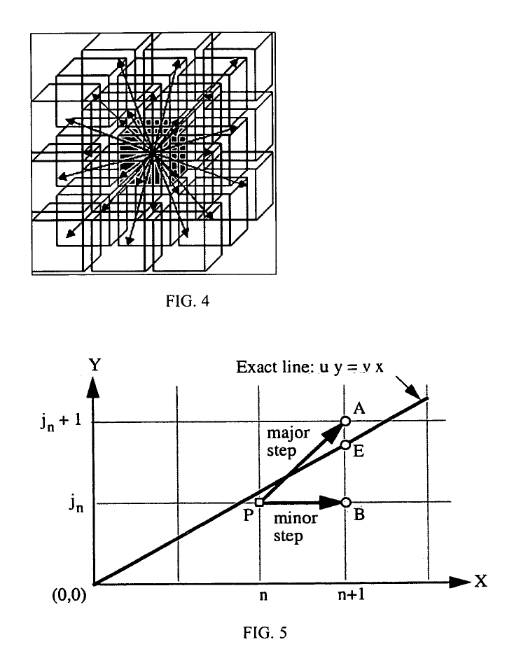

FIG. 4 is a diagram of a visibility map of a 3×3×3 matrix, according to an example embodiment. FIG. 4 shows how visibility map is divided equally. The visibility map is divided into 26 sections according to voxel format and visibility information from the center of each 26 sections is investigated to compute DOE of the voxel. In our application, visibility map is split into 26 sections, but the number of sections can be increased in order to obtain more precise visibility information.

To calculate DOE, the center of the voxel is placed at the origin (0, 0, 0) in Cartesian coordinate. For convenient calculations, a voxel size is assumed as 1×1×1. The center of 26 sections are (−1,−1,0), (−1,−1,1), (−1,0,−1), (−1,0,0), (−1,0,1), (−1,1,−1), (−1,1,0), (−1,1,1), (0,−1,−1), (0,−1,0), (0,−1,1), (0,0,−1), (0,0,1), (0,1,−1), (0,1,0), (0,1,1), (1,−1,−1), (1,−1,0), (1,−1,1), (1,0,−1), (1,0,0), (1,0,1), (1,1,−1), (1,1,0), and (1,1,1). To examine visibility from the center of each section, a ray tracing method is used. In order to determine whether the voxel is visible from a direction (a, b, c) in Cartesian coordinates, a ray toward direction (a, b, c) is shot from the center of the voxel. If it hits any solid voxel on the way, it means the voxel is not visible. In the other words, if a ray goes through all cavity voxels and finally hits a boundary, then a voxel is visible from the direction (a, b, c). Visibility from the direction (a, b, c) is obtained by investigating whether any solid voxel is in the way of the ray from the voxel to direction (a, b, c). In order to investigate the existence of solid voxel in the ray, all the voxels laid in the ray path are considered in calculation. 3D Bresenham algorithm is used for that purpose.

FIG. 5 is a diagram representing results of a Bresenham algorithm, according to an example embodiment of the invention. FIG. 5 explains Bresenham algorithm in a two dimensional domain. Assume a uy=vx line in a 2D domain and at this instance, location of the pen at “P” can make a diagonal step to-point A and a horizontal step to point B. If \overline{AE}<=\overline{BE}, it means the point A is closer to the exact line. Otherwise, the point B is closer than the point A to the line. The algorithm proceeds to the closer point and repeats to find next step.

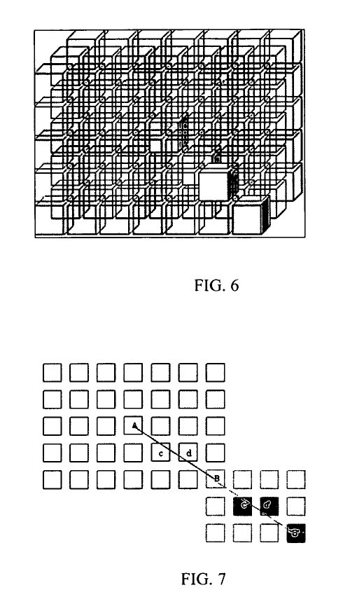

FIG. 6 is a diagram graphically representing the results of a Bresenham algorithm in three dimensions, according to an example embodiment. The Bresenham algorithm is extended to 3D domain. Assume a line

$$\frac{x}{u} = \frac{y}{v} = \frac{z}{w}$$

in a 3D domain and |u|>max(|v|,|w|). Then, it is possible to apply Bresenham algorithm to P:(x,y) and Q:(x,z) domain and the result will be a set of points as (x1,y1), (x2,y2), (x3,y3) . . . and (x1,z1), (x2,z2), (x3,z3) . . . . Then one can merge P and Q domain together using x. As a result a set of points (x1, y1, z1), (x2, y2, z2), (x3, y3, z3) . . . can be obtained. The example case is illustrated in FIG. 7.

FIG. 7 is a diagram graphically representing how the visibility of direction is calculated, according to an example embodiment. FIG. 7 explains how the visibility of direction (3,−2) is calculated. Assume a voxel A(0, 0) and direction vector B(3, −2). To investigate visibility of voxel A from the direction (3,−2), all the voxels in the ray A-B is examined whether the ray A-B goes through solid voxel or not. Accordingly, the direction AB (3,−2) is considered as invisible if one of voxel “c”, “d” or “B” is a solid voxel. If not, the algorithm is extended to next pattern by adding stepping vector (3, −2) to the all voxels. c(1,−1)->c′(4,−3), d(2,−1)->d′(5,−3), B(3,−2)->B′(6,−4). Then, examination is repeated to determine if c′, d′ and B′ voxels are a solid voxel or not. The visibility examination is extended until the range of the voxel pattern is out of the boundary. If the ray exceeds a boundary without meeting a solid voxel, the ray is visible in the direction B(3,−2).

### Filtering

In generic terms, filtering refers to the process of eliminating or preventing noise, thereby, allowing the program to identify the right candidates. In our program, noise may result from many different sources. Listed below are some of the sources and details of the way to handle them.

(1) Size of voxels: The size of voxels directly affects the efficiency and quality of results in our software. If the size of voxels is too small, then it will result in a large grid size. The size of grid is directly proportional to the amount of noise that has to be dealt with. A smaller size voxel may result in more such cavities to be identified, and hence more noise. On the other hand, a very large size of voxel may result in discretization errors i.e. the voxel representation may not be the correct representation of the protein. Also, it could also cause the algorithm to miss some significant cavities, which should have been identified.

(2) Solution: After testing the program with many different proteins and sizes of proteins, it is found that in an embodiment, the algorithm works well with a voxel size of 0.8-1.0 Angstrom.

Many candidates: As already stated, our algorithm identifies groups of connected internal cavity voxels, which are possible candidates of interaction sites. Due to several reasons, one may get a large number of possible candidates. Since one is dealing with small voxels in 3D space, the notion of noise is itself relative. For example, in the case of identification of internal cavity voxels, a small set of voxels may signify a smaller cavity. One may not be interested in smaller cavities as studies have shown that usually in a receptor the largest cavity is the interaction site. Even our results show that, the actual interaction site is usually among the top 3-4 candidates.

Solution: The number of sites to be identified has been kept as a parameter (NUMSITES) in the program, which can be changed. After identification of all possible groups of voxels, one sorts these candidates according to their size (usually a measure of volume or surface area). Then, based on the value of NUMSITES, one only selects the top few candidates and reset the labels of the other groups of voxels.

Inaccessible holes in the protein representation: The process of voxelization of the protein may also give rise to some noise. The process depends on the value of the threshold interaction distance, which again is a parameter in the program. After voxelization, the protein may consist of small internal holes and cavities that are not accessible from the outside and hence cannot be part of an active site. The above statement may not necessarily hold true primarily because protein is a flexible molecule and it may undergo structural and conformational changes during the process of its interaction with other molecules. But, our algorithm assumes the protein to be a rigid molecule, especially during the process of site identification. Hence, sites identified by our program are sites on the outside accessible surface of the protein.

Solution: Again after testing a lot with different threshold interaction distances, a value of 2.5 angstroms is settled on. Obviously, this parameter is also related to the size of the voxel too. To deal with internal cavities, the following methodology is presented:

(a) Mark all cavity voxels as internal cavity voxels. Usually, the process of elimination internal cavities is done before the start of any other processing. Before the start of this step, all cavity voxels were initialized as external cavity voxels. Also, at this stage the surface voxels have also not been identified.

(b) Group all internal cavity voxels into different groups. (Refer to the section of grouping).

(c) Sort the groups in descending order of their volume (size). Select the largest group and convert the voxels in all other groups as filled voxels. The largest group corresponds to the outer cavity surrounding the protein. All voxels belonging to this group are accessible from the outside or are visible in at least one direction from the outside. Cavity voxels belonging to all other groups are set as filled voxels. The atom-id of the closest atom for these voxels is set to NULL. This step ensures that these voxels won't be considered for visibility criteria check and hence won't be part of any cavity groups in the future processing.

(d) Reset back all the voxels belonging to the largest group as external cavity voxels.

Algorithm complexity: Since the algorithm starts off by marking all the cavity voxels as internal cavity voxel. This step takes O(N3) time. The next step in the algorithm groups these cavities, which also takes O(N3) time. Finally, the labels of the cavity voxels are reset. This step takes O(k) time, where k denotes the number of cavity voxels and is always less than N3. Hence, the overall algorithm takes overall O(N3) time, where N is the dimension of the voxel grid.

Mask size or maximum number of visibility directions per voxel: The number of visibility directions that are considered while determining the internal cavity eligibility criteria. Currently, a 3×3×3 mask is used, which translates into 26 different sample directions or sections. If one increases the mask size, it would increase the number of sample directions, and hence provide greater selectivity for various voxels. But increasing the mask size will make the program more susceptible to noise.

### Merging

During the site identification process, once the eligible internal cavity voxels are have been identified and grouped, the surface voxels adjoining these groups of voxels are identified and labeled as site voxels. To eliminate gaps and noise in this site identification process, one can use the protein information to fill in some of these gaps and to eliminate the noise content The algorithm can be briefly explained as below:

(a) After filtering and selection of top few candidates is completed, one can identify all surface voxels adjoining each group of these cavity voxels. Hence, corresponding to each group of cavity voxels, a set of surface voxels that may constitute an active or binding site is had.

(b) The surface patch or voxels that are identified as possible site voxels are then labeled as active site voxels. These site patches may contain some gaps and noises, which has to be eliminated. To eliminate these gaps, one takes each group of active site voxels and assign them unique group-ids.

(c) For each group of active site voxels, one marches the neighboring surface voxels for each voxel to identify voxels that satisfy certain visibility requirements and belong to the same residue. An important point to note here is that this process may result in the spreading of the active site. Hence, the visibility criteria for this process should be narrow and selective.

(d) The process of spreading, as explained above, may also sometimes result in two groups of site voxels being merged. To have an efficient implementation of merging, one maintains a mapping between group-ID and its reference group-ID. Initially, each group-ID is initialized to its own group-ID as the reference ID. But, whenever merging takes place, one selects the minimum of the two groupIDs being merged (lets call it gid1) and assign it as reference ID of the other (gid2). Then, one scans through the mapping table to find all groupIDs that contain gid2 as their reference ID and replace them with a reference ID of gid1.

(e) Finally, when all groups of site voxels have been processed, one resets the group-ID of each of the site voxel to the reference ID using the mapping table.

### Site Alignment

Problem Definition

Given a set of points from two mating or interacting surfaces, align them such that maximum partial match is identified. In the context of protein-protein docking and protein-ligand docking, these points represent the binding site regions on the proteins/molecules.

Algorithm Description

In the past decade, the point-cloud matching and alignment problem has received a lot of attention from researchers. Various different techniques have been applied towards solving this problem. Here an algorithm is presented, which tries to solve this problem using a paradigm called geometric hashing. Hashing is technique of storing input objects into bins that can be easily indexed. The algorithm steps have been broken into two categories based on which stage of the algorithm they occur. The various steps involved in the algorithm have been explained in the following section.

### Steps Before Geometric Hashing Based Alignment

Identification of binding site: Identification of voxels corresponding to the binding site regions on both receptor and ligand using voxel visibility as discussed before.

Identification of surface points: Calculate the molecular surface or Connolly surface points corresponding to the atoms in the binding region. A software MSMS and algorithms has been presented to compute r-reduced surface, r-excluded surface and r-accessible surface for a protein molecule given the radius of the probe solvent sphere. Molecules are often represented as a set S of overlapping spheres, each having the Van-Der-Waals radius of its constituent atom. The paper describes the algorithms for computing the analytical solvent excluded surface points and triangulation. It first computes the r-reduced surface, which is defined as the topological boundary of a set of atoms by adding r to the radius of each sphere denoting an atom. After defining the r-reduced surface of S, denoted Rr(S) they present an algorithm to compute its outer component in O[nlogn] operations and the corresponding Er(S) component in O[n] operations.

Alternatively, one can use the midpoints of the surface voxels at the binding sites of the voxelized protein. The voxelized representation of the protein will not yield smooth curvatures and surface-normals, which is used for comparison during the geometric hashing phase. It has also been discussed a method for computing normals and curvatures for the voxelized surface presentation.

Determination of neighborhood of the point-sets: Determine the neighborhood of each of these surface points either using triangulation or using threshold distance and store this information. The neighborhood of a particular point can be defined in two distinct ways. If the triangulation information is supplied, then the neighborhood of a point can be simply computed by finding all the points connected to this point by an edge. Alternatively, one can also determine the neighborhood information by selecting all points, which are within a threshold distance from the point in question. It has been discussed the importance of selecting the optimal value of the threshold distance “r”. The later method can be applied to both triangulated dataset and voxel dataset. For a voxelized model the neighborhood can also be computed by selecting immediate neighboring voxels. Every voxel in a voxelized model has up to 26 neighbors, which share a vertex, edge or face. But, out of these 26 neighbors only a fraction would be surface voxels at any given time.

Determination of surface normals: Obtain the normal information at each of the surface points. The molecular surface (Connolly Surface) representation computed by the MSMS program also returns the normals at each surface point on the analytical excluded surface. If the surface points being used are obtained from the voxel representation, then the normals can be computed using several methods. Several methods have been presented in the literature to compute the normals of the surface point cloud. I has been suggested a least square method based approximation of normals from a surface point cloud. It has been given a nice discussion on the effects of noise, curvature, neighborhood size, and sampling density on the normal estimation. A simple algorithm to compute normals of a voxelized model can be computed on the similar lines as follows:

First, determine the immediate neighbors of the current voxel as described in previously. Let's say that after doing this step one gets k neighbors for each voxel.

Using the k-neighborhood of a voxel, one can compute the least square best fitting plane through these k-neighborhood points. From the best fitting points the center and the unit normal can be determined. To obtain the magnitude of the normal principal component analysis can be used.

Determination of surface curvatures: Using the neighborhood information and the normal information the curvature at each point can be computed. It has been discussed methods to compute curvatures for triangulated set of points. Curvature is an intrinsic surface property i.e. it is not affected by the choice of the coordinate system. The surface curvatures, if computed stably, can act as a useful footprint during the matching phase of the geometric hashing algorithm. Currently, the method is used to compute curvatures. The method is essentially based on the Meusnier and the Euler theorem. Given below is a brief description of the theorem and the method for computation of the surface curvatures.

Principal Curvatures by Meusnier and Euler Theorem: Let N be the unit normal to the surface S at point P. Given a unit vector T in the tangent plane to S at P, one can pass through P a curve C⊂S, which has T as its tangent vector at P. Now let K be the curvature of C at P, and cos θ=<n,N>, where n is the normal vector to C at P, < > indicates the dot product between two vectors. The normal curvature κT is then given by the following relation.
κT=κ*cos θ (1)

Note that the sign of the normal curvature changes with the choice of the surface normal N. The Meusnier theorem states that all curves lying on S and having the same tangent vector T at P have at this point the same normal curvature. Among all these curves, a particular one is the normal section of S at P along T, which is obtained by intersecting S with the plane containing T and N. For this curve, the normal n is aligned with N, but with the same or an opposite orientation. Then, from equation (1) the curvature satisfies the expression κ=|κT|.

If one lets the unit vector T rotate about N, one can define an infinite number of normal sections, each of which is associated with a normal curvature κT. Among them there are two sections, which occur in orthogonal directions, normal curvature attains maximum and minimum value, respectively. These two curvatures are known as principal curvatures κ1 and κ2, their associated directions are called principal directions T1 and T2. The Euler theorem gives the relation between the normal curvature KT of an arbitrary normal section T and κ1, κ2 as follows:
κT=κ1*cos 2φ+κ2*sin 2φ, (2)
where φ is the angle between T and T1. Now, let
   ξ=cos φ and η=sin φ (3)
(|κT|)½ (|κT|)½

Hence, relation (2) becomes,
κ1*ξ2+κ2*η2=+1, (4)

Where the sign of the right hand depends on the choice of orientation of the normal N at P. Equation (4) defines what is known as Dupin Indicatrix of the surface S at P. It is seen that the Dupin Indicatrix is a conic defined by κ1 and κ2 in the tangent plane to S at P. If P is an elliptic point, the Dupin Indicatrix is an ellipse (κ1 and κ2 have the same sign). If P is a hyperbolic point, the Dupin Indicatrix is made up of two hyperbolas (κ1 and κ2 have the opposite sign). If the axes other than those in the principal directions are used, the Dupin Indicatrix would take the general form:
Aξ2+Bξn+Cη2=+1, (5)

Given these two theorems, a possible scheme to calculate the principle curvatures is as follows: let n plane curves (not necessarily normal sections) passing through the point P be given. For each of them, one can compute the curvature and the tangent vector (and thus the normal vector) at P. From the computed tangent vectors, the surface normal at P can be determined by applying a vector product to two of these tangent vectors. Alternatively, the surface normal could also be determined as a preprocessing step from the triangulation information. Using the equation (1), the normal curvatures along the n tangent directions are computed. Having chosen two orthogonal axes on the tangent plane to S at P, one can use equation (3) to compute a pair of coordinates (ξ, η) for each direction (Note that, at this time, φ is the angle between the tangent vector and one of the chosen axes). Thus one can obtain from equation (5). With n (n>=3) such equations, the three unknowns A, B, and C can be solved. Finally the principal curvatures κ1 and κ2 are:
κ1=½[A+C+√((A−C)2+4B2)], κ2=½[A+C−√((A−C)2+4B2)] (6)

The principal directions are determined by performing a rotation of the two orthogonal axes, in the tangent plane, by angle ψ where tan 2ψ=2B/(A−C).

Principal Curvatures neighborhood information: For each, point P on the surface, let us assume that one has a set Np of vertices, which are surface neighbors of P in different directions. (Refer to the discussion on neighborhood determination). The definition of surface curves can be simply done by selecting n vertex triples {T1=(P, Pi, Pj)|Pi, PjεNp, 1<1<n}, and to consider curves interpolating each triple of vertices as the surface curves. During the selection of triple of points, it is better to select curves closer to the normal section as cosine function is non-linear. In this way, the angle θ between the curve normal and the surface normal is closer to either 0 or π, which falls in the low variation range cosine, thereby minimizing the affects of computational error for angle θ. Geometric oppositeness of vertices usually results in a plane closer to the normal section. The measure of geometric oppositeness can be calculated as M=<P−Pi, Pj−P>. For approximating the kind of curve, usually, circum-circle is the most stable curve passing through a set if three vertices.

Now suppose one has chosen a set of vertex triples, {T1=(P,Pi,Pj), 1<1<n}. Each vertex triple defines an intersecting plane to the underlying surface passing through P. The center Ct of the circum-circle of these three vertices can be easily computed. Thus, the curvature and the unit normal vector of this circle at P are κ1=1/∥Ct−P∥ and n1=(Ct−P)/∥Ct−P∥, respectively. The unit tangent vector t1 at P is then given as:
t1=n1×(u×v)/∥n1×(u×v)∥ (7)
where u=Pi−P and v=Pj−P.

The normal curvature κt can be computed as κt=κ1 cos θ from equation (1). Now, there is enough information to compute equation (3) and then equation (5). Normally, n is greater than 3, so the three unknowns A, B, and C are often over-determined. One can, therefore, use the least squares technique to calculate them by minimizing the function.
G=Σ(Aξ12+Bξ1η1+Cη12−δ)2 (10)

Where δ=+1 according to the orientation of the surface normal.

Complexity Analysis: An algorithm of determining the curvatures of a set of surface points takes O(nk2) time, where n is the number of points on the surface and k is the neighborhood size. For a triangulated dataset, the neighborhood size is usually not that large, hence when is n is large, one can neglect the k. Thus, in effect the algorithm runs in O(n) time.

### Geometric Hashing Based Alignment

Geometric hashing: It is a computer vision technique for matching geometric objects against a database of such objects. It has been employed to recognize objects in am image that are partially occluded or have undergone geometric transformations. Geometric hashing uses an indexing-based approach for performing object recognition. The algorithm is highly efficient, runs in low polynomial time and is inherently parallel. This method is not only attractive in model-based schemes, but also, holds significant advantages in pair-wise comparisons because of its ability to identify partial similarity. Geometric hashing has been used extensively in various applications ranging from image recognition to computational molecular biology. It has been presented a general overview of the methodology followed by geometric hashing. According to the paper, the generic geometric hashing can be broken down into two phases. The two phases of the geometric hashing in 2D are given as below:

### Preprocessing Phase

For each model m do the following:

(1) Extract the model's point features. Assume that n such features are found.

(2) For each ordered pair in 2D or a triple in 3D, or basis, of point features. To illustrate for a 2D case do the following:
(a) Compute the coordinates (u, v) of the remaining features in the coordinate frame defined by the basis.
(b) After proper quantization, use the tuple (uq, vq) as an index into a 2D hash table data structure and insert int the corresponding hash table bin the information (m, (basis)), namely the model number and the basis tuple used to determine (uq, vq). FIG. 8 shows an illustration of the process in 2D.

### Recognition Phase

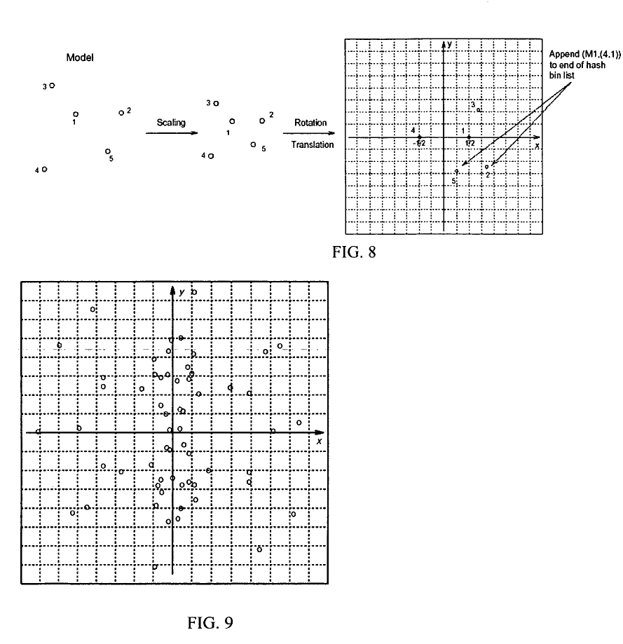

FIG. 9 is a diagram graphically representing a technique for obtaining hash table entries, according to an example embodiment. At this stage, the hash table consists of labeled entries generated using all possible bases for each model. FIG. 9 shows the state of a hash table after a 2D model M1 has been hashed into it. During the recognition phase, when presented with an input model, do the following:

(1) Extract the various points of interest. Assume that S is the set of interest points found. Let S be the cardinality of S.

(2) Choose an arbitrary ordered pair in 2D and triple in 3D, or basis, of interest points in input object.

(3) Compute the coordinates of the remaining interest points in the coordinate system Oxy that the selected basis defines.

(4) Appropriately quantize each such coordinate and access the appropriate hash table bin; for every bin found there, cast a vote for the model and basis.

(5) Histogram all the hash table entries that received one or more votes during step 4. Proceed to determine those entries that received more than a certain number or threshold, of votes. Each such entry corresponds to a potential match.

(6) For each potential match discovered in step 5, recover the transformation T that results in the best least squares fit between corresponding feature pairs.

(7) Transform the features of the model according to the recovered transformation T and verify them against the input object features. If the verification fails, go back to step 2 and repeat the procedure using a different basis pair.

Most of the geometric hashing implementations follow a somewhat similar approach, except for the selection of the basis. In general, in the absence of any discriminating information, 3 points are required from the point cloud to form a basis in 3D. This brute force algorithm takes O(Mn14) time in the preprocessing stage and O(Hn24) time in the recognition phase, where M is the number of models, n1 is the number of feature points in each model, n2 is the number of feature points in each object/image, and H is the average number of entries in each bin. Using a custom basis, the algorithm complexity can be brought further down. For example, it has been proposed that a O(Mn2) algorithm for 3D substructure matching. The algorithm uses only the C-alpha atom coordinates for performing geometric hashing. It builds an invariant basis/coordinate system for each amino acid centered at the C-alpha atoms. The algorithm also combines the geometric hashing with χ2 test based clustering for obtaining sub-structure similarity. Others have proposed a geometric hashing based method for matching partial surface and volume. The method treats the rotation and the translational component of the rigid motion separately. The algorithm associates with each point an invariant footprint/basis (which could change with application to application) that signifies a good local neighborhood match. The algorithm constructs a voting table for each rotation and then scores them. The algorithm, then, uses a steepest decent algorithm to arrive at the best rotation. Finally, the correct translation is achieved. The algorithm seems to be promising, except for the fact that it depends heavily on the footprint being selected and it assumes a presence of a significant global maxima in scoring of various rotations during the steepest decent phase. It has also been proposed to use geometric hashing for predicting protein-protein docking and protein-ligand docking. The algorithm first identifies a set of interest points and their corresponding normals on the surface of the protein using the Connolly's MS-Dot program. The algorithm then uses geometric hashing to identify potential docked complexes using geometric hashing. They use a pair of points and their normals as the invariant basis in 3D, instead of three points (minimum required). The interest points selected on the surface is based on the Knob and Hole concept proposed originally by Connolly.

In most geometric hashing based algorithms, the non-uniform distribution of indices over the index space results in inefficiencies. For instance, non-uniformity of the index distributions results in bins that contain large number of entries. Hence, the time complexity of the recognition phase might be adversely affected. A simple solution to this problem is to reduce the size of hash table bin. But, that will increase the storage requirements and also might affect the results during the recognition phase. There has been proposed a rehashing method to transform the non-uniform index space to a relatively uniform space. It has been proposed the use of Self Organizing Map to tackle the problem of non-uniformity of the index space.

Model-based object registration or preprocessing stage: In an embodiment, a set of surface points corresponding to the possible binding site on both receptor and ligand is acquired. The next step is to align these sets of point cloud so that maximum surface points are in matching. To achieve this, one employs geometric hashing algorithm. The first step in any geometric hashing based algorithm is to index the model object coordinates into the hash-table. The model object coordinates could correspond to either receptor s or ligands. Without the loss of generality, let us assume that they represent receptor binding sites for all further discussions. During this step, the model object coordinates are determined for each invariant basis and stored into the hash-table. Hence, each point is redundantly stored many times in different coordinate systems defined by individual invariant basis. As mentioned earlier, 3 points are required to define a unique coordinate system in the 3D space. Hence, the classical geometric hashing algorithm, requires O(Mn4) time. This time complexity can be reduced further by using some application specific information. For instance, some have reduced it to O(Mn2) by using the property of proteins that the N—Ca—C angle in all amino acids fall within a small range. And hence can be assume to rigid or constant, thereby, enabling them to define a unique coordinate system at each amino acid. Similarly, some have selected two surface-points and their corresponding normals as a basis, which allowed them reduce the running time of their geometric hashing implementation to O(Mn3). (The complexities described above are only for the preprocessing stage.).

In the algorithm, an invariant basis is selected in such a manner that the complexity of our geometric hashing algorithm is O(Mn2) and the recognition phase runs in O(Hn2) time, where H is the occupancy of each bin and M is the number of models. The invariant basis that is used takes just a point on the surface, its corresponding normal, its principal curvatures, and its principal curvature directions. The algorithm uses the pre-computed normals and curvatures associated with each surface point, as described in the previous section. The principal curvature directions along-with the normal at a point uniquely define a coordinate system at each surface point. But, curvature determination is highly prone to noise, especially as regards to the principal curvature directions. Hence, one can't rely on the principal curvature directions. Also, due to insufficient neighborhood size and noise, at some surface points the curvature cannot be determined. A methodology is adopted to tackle these issues. For each point/basis, one first hashes all the points on the model surface into the hash-table using the coordinate system defined by the principal curvature directions and the normal. One then rotate these coordinates by small angle increments (e.g. 5 degrees) in both clock-wise and anti-clockwise directions about the normal. For a point, with well-defined principal curvature and directions, one defines a threshold value (say +45 degrees) in both clock-wise and anticlockwise directions, till which the rotations are performed. For a point where the curvature information cannot be determined or the data appears to noisy, one increases this threshold is such a manner to cover all possible directions (threshold=+180 degrees). Hence, in the worst case with a 5 degrees increment and a threshold of +180 degrees, one has to sample 72 directions. This sample size is a constant and is negligible when dealing with large point-sets. One can increase the neighborhood size by using a different methodology of neighborhood determination (refer to previous section). Thus, one will have very few points on the surface, where the curvature information cannot be robustly calculated.

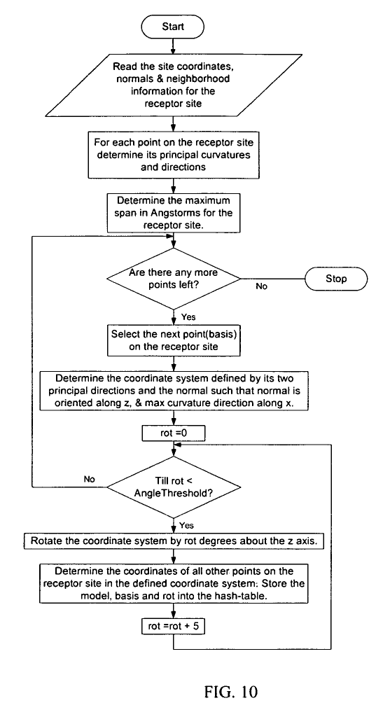

Another key point to note here is that, the hash-table bin size plays a key role in the determination of the efficiency and the accuracy of the geometric hashing algorithm. Hence, the hash bin size should be selected carefully based on the application at hand. Also, the type of hash-table used can also make a lot of difference. The various steps involved in the registration phase of our geometric hashing algorithm have been described by a flowchart given in FIG. 10.

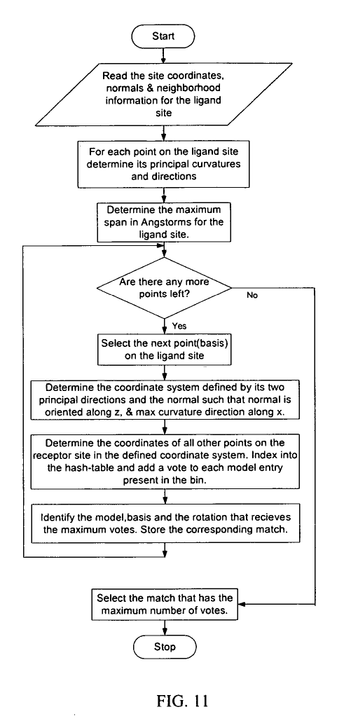

Object Recognition Phase: After the preprocessing phase, the next step is to find the best matching model configuration for each ligand from the database of ligands. As described earlier, in the recognition phase of the geometric hashing algorithm, invariant bases are extracted from the feature models (ligands) and all the feature points are indexed into the hash-table using these bases. Votes are cast for each model entry found in these indexed bins. A histogram is then constructed using the models and the votes received by each of them. A model with high number of votes may signify a potential match. Hence, these high scoring models are aligned with the features (ligands) and subsequently scored. The correspondence between the matching points in the receptor the ligand can also be stored and used for refining the alignment. The extraction of the invariant basis and the hashing process is similar to that of the registration phase. The steps involved in the recognition phase have been described in FIG. 11.

Alignment transformation: After the best match between the receptor and the ligand has been identified they need to be aligned before the match can be scored. Two possible ways of performing this alignment process have been listed below:

Using the corresponding invariant bases: The geometric hashing process essentially tries to align the coordinate systems defined by the model's invariant basis and the database feature's invariant basis. Hence, the geometric hashing process automatically provides us with an alignment as well.

By minimizing the RMSD between the matching points: Although, the geometric hashing process provides us with an alignment, too. But, the alignment may not be the best alignment and depends on several factors like bin size, number of matching points, etc. One can, alternatively, align the model and the database feature by minimizing the RMSD between the point correspondences generated during the hashing process. This can be done by using Singular Value Decomposition [ ]. The process can be roughly broken down into the following steps:

(a) Setting up the objective function: Let yi denote the coordinates of points in the receptor point-set and xi denote the coordinates of the corresponding matching points from the ligand point-set. Our aim is to minimize the root-mean squared distance between these matching points. Hence, one wants to find a rotation R, so as to minimize
1/NΣ(yi−R.xi)T(yi−R.xi) (11)
where N is the number of matching points found.

The (11) can be rewritten as,
1/NΣ(yiTyi−2yiTRxi+xiTxi) (12)

To minimize (12), one needs to maximize the middle term,
ΣyiTRxi (13)

(13) can be rewritten as
(RTΣyixiT)T (14)

Hence, our objective is to maximize (14).

(b) Maximizing the objective function:

In (14), the sum is called the correlation C. Hence, one wishes to maximize
trace(RTC) (15)

Now, lets decompose C using singular value decomposition, which can be expressed in an equation form as given below:
C=UWVT (16)
Where, U and V matrices are orthogonal and
W is a diagonal matrix containing singular values

Substituting (16) in (15), one gets,
trace(RTC)=trace(RTUWVT) (17)

Since trace(AB)=trace(BA), (17) can be written as,
trace(RTUWVT)=trace(VTRTUW) (18)

Since W is diagonal matrix, only the diagonal of VTRT U matters for trace.

And since V 0R0U is orthogonal, the biggest diagonal is when
VTRTU=I (19)

Hence, the rotation that minimizes RMSD is given by
R=UVT (20)

The rotation matrix may sometimes contain reflection transformation i.e. det(UVT)=−1. Equation (20) can be easily adjusted to account for this fact.

Scoring: After the two point-sets have been aligned, one needs to determine the good-ness of the alignment. Since, one is dealing with point-sets on the surface of proteins and molecules; penetration of interacting regions is not desired. Apart from the surface contact and penetration, one also needs to evaluate if the predicted complex is energetically favorable or not. To address these issues, two different methods of scoring are used. The two scoring schemes have been given as below:

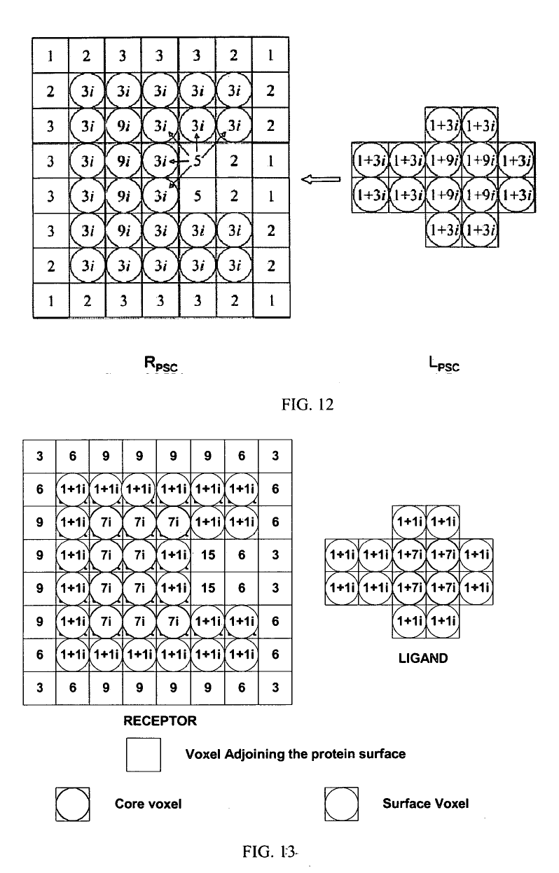

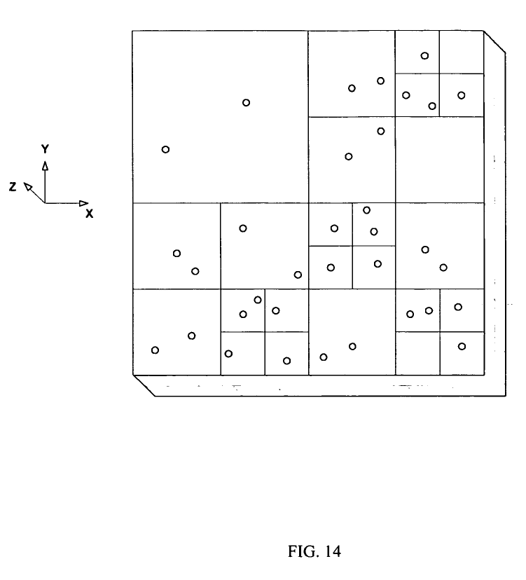

Scoring the surface contact: A scoring scheme is used to score the surface contact between the two molecules. This uses the discretized representation of the protein/molecules and assigns each grid entry with a complex number based on whether it is a surface voxel or core voxel or outside voxel. The assignment is based on the consideration that every surface-surface voxel contact should get a positive score and any contact with a core voxel should be penalized. In the paper, they use a fast Fourier transform based method to predict the potential complex structure. To illustrate the method, it is briefly described a scoring scheme and method. They first discretize or voxelize the receptor. Then, they keep the receptor fixed at the origin, and sample the rotational space at 15 degrees interval using Euler angles. For each sampled rotation, they discretize or voxelize the ligand. During discretization, they assign a complex number to each grid voxel. This is done according to the following scheme (refer to FIG. 12). For any overlapping voxels between the receptor and ligand, the multiplication of the scores of the voxels is added to the overall docking score. Based on the similar lines, FIG. 13, shows the scoring criteria adopted. The reason for this different scoring is that one wanted to assign a higher score to surface-surface contact and a smaller penalty for a core-surface contact or core-core contact.

Scoring the energy for the configuration: A predicted complex must also have a favorable energy to support its formation. There are different ways in which one could evaluate the energy state of a particular complex. Listed below are three possible methods:

Using residue based statistical potential: It has been developed residue-based pair-wise statistical potentials for protein-protein interactions. The statistical potentials were developed using two datasets DIMER1 and DIMER2 containing 768 and 428 protein complexes, respectively. The interfacial pair potentials, P(i,j) are calculated by examining each interface of the protein complex using the following formula:
P(i,j)=−log{Nobs(i,j)/Nexp(i,j)} (21)

Where Nobs (i, j) is the number of observed interacting pairs i, j between the two protein chains. Nexp (i, j) is the number of expected interacting pairs i, j between the two protein chains, if there are no preferential interactions among them. The expected number can be calculated from:
Nexp(i,j)=Xi*Xj*Ntotal (22)

Where Xi is the mole fraction of residue type i. Ntotal is the total number of interacting pairs.

Using the above described methodology, they have developed a database of pair-wise statistical potentials for protein-protein interactions. From their tests, they have determined that a energy threshold of −15 is good enough to discriminate true-dimers from false ones.

The same research group also worked on the development of a distance-dependent atom-based statistical potential for scoring the interactions between the two molecules. One could use this statistical potential for scoring the conformation predicted by our program. Similarly, one can also use actual energy terms to score and optimize the energy interactions between the two molecules.

Refinements: The alignment predicted above is based on the notion of shape complementarities. The scoring of the alignment gives us an indication of how good the alignment really is. Any practical docking program has to combine both geometric and energetic aspects. One believes that after obtaining a good approximate alignment, one can improve the alignment further by optimizing the energy of the complex using commonly used software like CHARMM. Most of these softwares mainly consist of two things: an energy model that computes all the components of the energy and an optimization method, like steepest decent, simulated annealing, etc, that minimizes this energy. Because of the iterative nature of the optimization methods, the performance of such systems depends largely on the availability of a good starting point. One believes that the alignment generated by our geometric hashing algorithm could serve as a really good starting point such systems to work. The energy optimization based techniques can improve the predicted alignment further.

Enhancements: As discussed earlier, in most geometric hashing based algorithms, the non-uniform distribution of indices over the index space results in inefficiencies. For instance, non-uniformity of the index distributions results in bins that contain large number of entries. Hence, the time complexity of the recognition phase can be adversely affected. A simple solution to this problem is to reduce the size of hash table bin. But, that will increase the storage requirements and also might affect the results during the recognition phase. It has been proposed a rehashing method to transform the non-uniform index space to a relatively uniform space. [ ] has proposed the use of Self Organizing Map to tackle the problem of non-uniformity of the index space. We, too, have tried to exploit the distribution of indices to build the hash-table. The algorithm combines geometric hashing with an OctTree-based adaptive subdivision method. The algorithm steps are similar to the geometric hashing steps described in previous sections, except:

During the registration phase, when the model and basis pair is about to be stored into the hash-table, one employs the OctTree based subdivision technique. The technique can be briefly described as follows:

March the Oct-Tree using the coordinates of the point to be indexed till a root-bin/node is reached.

Insert the index into the bin/node.

If the size of the node is greater than a threshold value, split the current bin into 8 different bins and re-distribute the indices in the original bin into the newly-created eight child-bins.

During the recognition phase, when one is about to index the hash-table, one has to march the OctTree to determine the bin/node to index into. FIG. 14 illustrates the adaptive subdivision method for a hypothetical case.

Complexity: With the use of an OctTree-based adaptive subdivision technique, one can't directly access a bin in the hash-table without marching the OctTree. Hence, the complexity of our algorithm is different from what was established before. For the recognition phase, the marching of the OctTree takes O(log8 n) time. The process of splitting is done in O(1) time, since the threshold on the max number of entries in any bin is a small constant value (usually between 1-100). Hence, the overall time complexity of the registration phase is O(n2 log8 n). Also, one has to march the OctTree during the recognition phase too. Hence, the time complexity for the algorithm O(n2 log8 n).

### Proposed Alternate Alignment Methodologies

Using the principal moment directions: Once the site information is identified on both the receptor and ligand, they can be aligned using their principal moment directions in the following manner:

Extract the first and second order moments for the extracted site information and construct the moment matrix. The moment matrix is given as below:

$$\begin{matrix}M = [ \begin{matrix}{κ}_{200} & {κ}_{110} & {κ}_{101} \\ {κ}_{110} & {κ}_{020} & {κ}_{011} \\ {κ}_{101} & {κ}_{011} & {κ}_{002}\end{matrix} ] where , \\ {κ}_{lmn} = {\sum }_{k} {( {X}_{k} - \overline{X} )}^{l} {( {Y}_{k} - \overline{Y} )}^{m} {( {Z}_{k} - \overline{Z} )}^{n}\end{matrix}$$

The terms along the main diagonal denote the second order moments and rest of the terms are first order moments.

From the moment matrix, obtain the three orthogonal principal moment directions for each site.

Align the two sites, aligning their principal moment directions.

Extract the centroid of the two sites and super-impose them.

The principal moment directions are very sensitive to small changes in the distribution of the mass. Hence, the alignment obtained from this method will not be exact. But, at the same time, the calculation of second order and first order moments and subsequent alignment can be done in a very fast time. This alignment has to be followed by an energy minimization based refinement to get the correct prediction. Since, energy minimization based method depends on a good initial start, which can be provided by using principal moment alignment.

### Surface Matching

Overall Description

This part of report deals with solving the problem of matching two surfaces in context to matching active/binding site on molecular surface. The two surfaces can either have local similarity or they can match globally. Two surfaces S1 and S2 are said to match exactly if the point of S1 and S2 corresponds. This means that there exist a transformation function f such that S1=fS2. However, due to noise the surface will not match exactly, so one should account for errors. In the local matching problem, a subsurface of S1 will match with subsurface of S2. Let R1 be a subsurface such that R1 is subset of S1, similarly R2 a subset of S2, one will say there is a local match between S1 and S2 if there exist a transformation function f such that R1=fR2, taking error into account. Our task is to find maximal subset R1 that matches with maximal subset R2. For a given pair of surface there may be several such pair of subsurface. The main task here is to find maximum number of such pair of sub surfaces, having same transformation function f.

The major consideration while developing surface matching algorithm was it should be fast enough so that scanning of large database is feasible without any need of state of the art computer clusters. Some of the applications of surface matching algorithm are described below:

It helps in fast screening of database for reducing the number of docking candidates. Suppose one has a protein molecule, and one would like to identify all other protein molecule in the database that can bind with this molecule. If one does the site alignment for all the proteins then the algorithm complexity in terms of time will increase. However, since one knows a priori that for two molecules to bind with each other they should have complimentary shape. The surface matching algorithm will do the fast screening of database to identify all the molecules that has complimentary binding site surface with the site surface on the target molecule. So now instead of performing alignment on the whole database it will be done only on the small selected set of molecules that are more likely to bind to target molecule. In other scenario, in drug discovery process if one wants to find all protein molecules that can bind the given drug molecule, one can perform the similar pre-screening of database before doing the alignment. This type of analysis will help in understanding the efficacy and specificity of drug molecule.

With the advancements in structural genomic projects it is expected that many new protein tertiary structure will be produced, and some of the structure may be determined even before their bio-chemical functions are known. Initially, it was believed that proteins having sequence similarity share same functions. Then it was discovered that overall structure similarity is better descriptor of same functions. Recent studies had found many examples in which, (1) the two proteins have similar biochemical functions, but their structure is completely different, and (2) the structure is similar but the biochemical functions are different. In many cases, biochemical functions of proteins are governed by intermolecular interactions, which is due to shape complementarities of the molecular surfaces. The portion of molecular surface which is interacting with other molecule is defined as binding site. Thus to find out the functional similarity between two proteins it is necessary to find whether their binding sites are similar. If their binding sites are similar it can be predicted that they will behave in the similar manner with an approaching ligand, thus sharing same biochemical functions.

Algorithm Description

To search for a surface with similar geometry, the molecular surface representation generated by Connolly's algorithm is used. Molecular surface points corresponding to atoms in the binding are calculated using software MSMS. For details on identification of surface points please refer to section 8.2.1.2. After the surface points are calculated there are two options to be considered for matching. First, use all the surface points and identify all the points that correspond. But, if one uses all points time complexity will increase and one is interested in quick way of comparing two surfaces. Therefore, one has come up with a method where instead of using all points one identifies point of interest on the surface and perform matching operation using those points, one names those points as Feature Point or Critical Point.

Identification of Feature Points

Feature points are defined as the points having either maximum or minimum curvature (Gaussian or Mean). Depending on the type of match one wants to perform the definition of feature points will change a little. If one is interested in finding global match, then there may be only one feature point for the entire site surface, and that feature point is the point with global maximum curvature if the surface is convex (protrusion or bump) or global minimum curvature if the surface is concave (cavity or pocket). In case of local matching, there may be many matching subsurface, so one has to identify feature point for each subsurface. The feature point is defined as point representing local surface properties. A local feature point (p) is identified by considering all points in the neighborhood of p, whose distance from p is less than threshold distance NBDIS. Hence in local matching, feature point is a point with local maximum or minimum curvature.

Shape Descriptor

For local matching of surface, one uses as feature points, those points where the local Gaussian or mean curvature is maximum or minimum. One wants to find match between subsurface, matching the feature point alone won't help therefore for each feature point one constructs shape descriptor, such that it captures the shape property of local surface around that feature point. The shape descriptor can also be called as Shape Signature, uniquely representing the profile of local shape. One has two different options for constructing shape signature:

Histogram Based

Let C be a set of point which are at distance less than NBDIS from feature point p. One then defines the distance map of C as set of distances of all point in C from p. In the next step, one discretizes the distance map into array of distances. Thus the signature of shape of local surface around feature point p is represented in terms of histogram. To find if the two surface patch match one will use histogram matching techniques.

Contour Based

One has another method for representing shape of surface, in this method instead of having one signature for a surface one has multi level signature. One first calculates a set of contours (S), where each contour is at certain distance from feature point p. A contour is defined as closed curve that is at a distance (R±TOL) from point p, where R is incremental distance from p with increment INCR and maximum value equal to NBHD. Each contour is represented by its unique signature that helps in fast matching.

Let C be a set of points in contour and q is centroid of contour C. One then defines the distance map of C as set of distances of all point in C from q. In the next step, one discretizes the distance map into array of distances and represents that in terms of histogram H. Now, one has representation of surface as a set of contours S, where each contour is represented as histogram H. This is the multi level signature of surface. The steps involved in matching two surface region represented by multi level signature are:

Start from contour at the bottom level, nearest to feature point.

Match contour using histogram matching technique

Based on the number of matching contour one can identify the percentage similarity between two surfaces.

Histogram Matching Technique

Many researchers have worked on solving the problem of finding global match between 3D shapes using histogram matching technique. Based on the published results, the histogram matching techniques works fine if the task is to find global match between 3D shapes, however for finding local match it doesn't have any direct application. In the current invention, one has broken down the problem of finding local match in shape to a level where one can utilize the histogram matching technique. Instead of constructing a histogram for global shape, one is constructing local histogram and matching them will find local match. In the previous section one has described two different techniques of representing local shape as histograms. The following section will describe how one will match two histograms to predict similarity between shapes.

The histogram representation is first converted into probability distribution function. There are many different ways for obtaining similarity score of two probability distribution function f and g. One uses the following two different methods
χ2 Method: D(f,g)=1−∫\sqrt{Z(fg)}
Bhattacharyya Method:

$$D ( f , g ) = \int \frac{{( f - g )}^{2}}{( f + g )}$$

### Clustering

Overall Description

Given the size of molecular database and its growth rate, performing a brute force searching for finding docking candidate for a target molecule is both time and resource consuming. Such brute force method will predict large number of possible candidates including misleading false-positive information. Therefore there is a need for method that will screen the database smartly, identifying candidates that are more likely to dock with the target molecule and eliminating obvious negative cases. It is proposed to use clustering method to meet the above mentioned need.

Using clustering algorithm one intends to group all molecules having similarity in binding site. From the argument presented in previous section, one knows that molecules having similar binding site, tend to have similar function. Also, similar binding site molecule are more likely to bind with the same target molecule. Therefore, one can say: all the molecules that belong to a group in cluster, share same functions and have greater probability of forming a bond with the target molecule.

The above statement can be state in other word as: if one has a representative molecule for a group in cluster and if one can find that the representative molecule can bind with the target molecule, then one can say with high degree of confidence that all molecules in that group are likely to bind with the target molecule. In this way, one can apply our more comprehensive docking algorithm on focused set of candidate, for identifying molecules that can actually bind with target molecule. Thus one has saved themselves from searching the whole database. This method of pre screening database to identify focused set of molecule will prove to be smarter and efficient.

Clustering Algorithm

Various clustering algorithms have been investigated that can be used. In the previous section it was described how one represents binding site surface using local signatures and technique for finding match between two surfaces using their signature. The same signature and matching technique described above are used as similarity metric in clustering algorithm.

Each group in the cluster will have representative set of signatures. As the name suggests, the representative set will encompass property of all molecules in group.

Hierarchical Clustering: In hierarchical clustering the data are not partitioned into a particular cluster in a single step. Instead, a series of partitions takes place, which may run from a single cluster containing all objects to n clusters each containing a single object. One will use agglomerative method of hierarchical Clustering, which proceed by series of fusions of the n objects into groups. At each particular stage the method joins together the two clusters which are closest together (most similar). There are several agglomerative techniques that can be used here:
Single linkage clustering
Complete linkage clustering
Average linkage clustering

Self Organizing Maps (SOM): A SOM has a set of nodes with a simple topology (e.g. two dimensional grid) and a distance function d(N1,N2) on the nodes. One chooses geometry of “nodes”—for example a 3×2 grid. The nodes are mapped into k-dimensional space, initially at random, and then iteratively adjusted. Each iteration involves randomly selecting a data point P and moving the nodes in the direction of P. The closes node NP is moved the most, whereas other nodes are moved by smaller amounts depending on their distance from NP in the initial geometry. In this fashion, neighboring points in the initial geometry tend to be mapped to nearby points in k-dimensional space. The process continues for 20,000-50,000 iterations. SOM imposes structure on data, with neighboring nodes tending to define related cluster.

Applications:

Some possible applications of our geometric complementarily based alignment tool are: Prediction and study of Protein-protein interactions and protein-ligand interactions. Mechanical feature recognition (bosses and holes). Automated assembly of mechanical parts with curved mating surfaces. Feature recognition from medical image scans like CT scan and MRI scans. Can be used for building protein interaction database, which could aid in the research on protein pathways and systems biology. During target identification, Target Validation, High-Throughput Screening and lead optimization phases of drug discovery.

It is now understood how machines may autonomously discover and enforce policies on a network by soliciting advice from peers. Moreover, the policies may be altered globally via administrative controls and monitors. These techniques permit more automated network administration having improved controls and monitoring capabilities.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
acquiring site coordinates and neighboring information for a receptor site of a given protein or a ligand;
determining principal curvatures and directions for each coordinate point of the receptor site or the ligand;
determining maximum span for the receptor site or the ligand;
iterating for each remaining site coordinate of the receptor site or the ligand; and
indexing the given protein, the site coordinates, the neighboring information, the points, the principal curvatures and directions, the maximum span, and the receptor site or the ligand in a data store.

2. The method of claim 1, wherein acquiring further includes acquiring each of the site coordinates as a unique three-dimensional coordinate represented within the given protein.

3. The method of claim 1 further comprising, representing the principal curvatures, the directions, the maximum span, and the neighboring information as a vector for the receptor site or the ligand and storing the vector in the data store with the given protein.

4. The method of claim 3 further comprising, forming a composite vector for the given protein from the vector associated with the receptor site or the ligand and from other vectors associated with other receptor sites of the given protein or other ligands.

5. The method of claim 1 further comprising:
receiving a candidate portion of a different protein or drug molecule;
re-iterating the method with the candidate portion or the drug molecule to acquire candidate principal curvatures, candidate directions, and candidate maximum spans; and
searching the data store with a vector representing the candidate principal curvatures, the candidate directions, and the candidate maximum spans in an attempt to find a matching receptor site or matching ligand in the data store for the candidate portion or the drug molecule.

6. A method, comprising:
acquiring a graphical representation of a given protein;
projecting the graphical representation onto a grid;
identifying cavities and protrusions within the graphical representation using the grid; and
generating a protein from the identified cavities and protrusions.

7. The method of claim 6 further comprising, associating shape features with each of the identified cavities and protrusions, wherein the shape features are retained within the generated protein model.

8. The method of claim 7 further comprising, indexing and storing the shape features, the grid, the cavities, the protrusions, and the protein model in a data store.

9. The method of claim 6, wherein identifying further comprises determining a distance visibility from a given point within the grid to a stopping point, and wherein the stopping point identifies the start of one of the cavities or one of the protrusions.

10. The method of claim 6, wherein determining further comprises inverting the grid to identify the protrusions as a number of the cavities.

11. The method of claim 6 further comprising, grouping features of the protein module into similar types of structures which are identifiable from the grid.

12. The method of claim of claim 6 further comprising, ranking the cavities, wherein higher ranking cavities are more likely to be active sites within the given protein, and wherein the ranking is based on a size associated with each of the cavities.

13. A method, comprising:
acquiring features of a given protein from a data store;
using the features to present a three-dimensional graphical representation of the given protein on a display; and
interactively receiving instructions via an interface to zoom in or out or pan around to selective portions of the presented protein.

14. The method of claim 13 further comprising:
receiving a selected portion of the given protein as a search term;
querying a data store on the selected portion; and
returning candidate matches from the data store, which substantially conform to the search term.

15. The method of claim 14 further comprising:
clustering the candidate matches into one or more groupings; and
permitting each group to be browsed via the interface.

16. The method of claim 13 further comprising:
receiving text-based information as an additional search term; and
modifying the search term with the additional search term to perform a different query against the data store.

17. A method, comprising:
receiving a graphical search term for a portion of a given protein or for a drug molecule;
reducing the graphical search term into features associated with a vector;
searching a data store with the features to predict portions of previously indexed proteins or previously indexed drug molecules that bind with the portion of the given protein or the drug molecule; and
returning results for predicted binding proteins or predicted binding drug molecules.

18. The method of claim 17 further comprising, permitting the features of the graphical search term to be manually modified and re-performing the searching and the returning of the results.

19. The method of claim 17 further comprising, representing the results as percentages, wherein each percentage corresponds to a predictive value indicating to what degree a returned predicted binding protein or returned predicted binding drug will bind with the portion or with the drug molecule used with the graphical search term.

20. The method of claim 19 further comprising, ranking the results in response to the percentages.

21. A method, comprising:
mining a data store for similar portions of different proteins or different drug molecules;
clustering similar groupings found during mining into hierarchical arrangements; and
presenting a hierarchy associated with the similar groupings for browsing.

22. The method of claim 21 further comprising, performing targeted searches on one or more select ones of the similar groupings on a received graphical representation or a portion of a given protein or drug molecule.

23. The method of claim 21 further comprising:
presenting a selected similar grouping within a display; and
interactively zooming in or out or panning on selected portions of the similar grouping.

24. A method, comprising:
generating a node histogram for an active site or a binding site or a given protein;
determining distances between the active site or the binding site to other different active sites or binding sites; and
creating a model characterization for the active site or the binding site from the node histogram and the distances.

25. The method of claim 24 further comprising, substantially matching the model characterization to one or more different active sites or binding sites or a drug molecule.

26. The method of claim 24 further comprising, indexing and storing the model characterization for subsequent search and retrieval.

27. The method of claim 24 further comprising, using the model characterization as a search term for a search query to find a potential active site or a potential binding site that substantially matches the active site or the binding site.

28. A system, comprising:
one or more data stores to house feature's of proteins and drug molecules;
a data abstraction service to graphically represent and present the features, the proteins, and the drug molecules;
one or more tools to mine, search, query, and predict reactions and interactions of the features, the proteins, and the drug molecules and to receive candidate features, candidate proteins, and the drug molecules for comparison and prediction against the one or more data stores; and
an interface to permit the tools to be accessed and the data abstraction service to be accessed in response to directives received through the interface.

29. The system of claim 28, wherein the one or more tools include a query service to query the data store, a mining service to analyze and mine the data store, a prediction or docking service to predict the reactions and interactions, and population service to populate the one or more data stores with the features, the proteins, and the drug molecules.

30. The system of claim 28, wherein at least a portion of the features are acquired from an external repository.

31. The system of claim 28, wherein at least one of the tools is a service that dynamically creates the candidate features from a graphical search term supplied via the interface.

32. The system of claim 28, wherein the interface issues searches and queries via select ones of the tools and receives results, which are presented on a display.

33. The system of claim 28, wherein the searches and queries are dynamically identified by selecting portions of the features presented on the display by the data abstraction service.

34. A system, comprising:
grid mapping service;
a feature extraction service, wherein the grid mapping service is to map a graphical portion or drug molecule into a grid of coordinate points, and wherein the feature extraction service is to identify features of the coordinate points and linkages between features, and wherein a number of the features include active and binding sites for the graphical protein or drug molecule.

35. The system of claim 34 further comprising, a visualization service to present the features and the linkages graphically on a display.

36. The system of claim 34 further comprising, a clustering service to dynamically cluster the features with other previously identified features associated with other proteins or other drug molecules.

37. The system of claim 34 further comprising, a search and query service to search and query a data store using one or more of the extracted features.

38. The system of claim 34 further comprising, a scoring service to score each of the linkages identified with the features.

39. The system of claim 34 further comprising, a prediction service to mine a data store for other portions of proteins or other portions of drug molecules that bind to one or more of the features.

40. A data store implemented in a machine-accessible medium for storage and retrieval of features associated with proteins and drug molecules, the data store comprising:
a protein or drug molecule identifier;
a plurality of coordinate points associated with various portions of each protein or drug molecule identifier;
neighboring information associated with each coordinate point;
a maximum span associated with each coordinate point; and
normal features associated with each coordinate point;
wherein the information associated with each drug molecule is indexed and accessible collectively or individually from the data store.

41. The data store of claim 40, wherein the neighboring information includes link attributes for coordinate points that are in proximity to one another within a configurable threshold distance.

42. The data store of claim 40 further comprising, presentation information to define presentation attributes of the neighboring information, the maximum span, the normal features, and the coordinate points.

43. The data store of claim 40, wherein a number of the coordinate points associated with each protein or drug molecule identifier is identified as receptor sites or ligands of a given protein or drug molecule.

44. The data store of claim 43, wherein the receptor sites or the ligands further include scores that identify the likelihood that they are legitimate receptor sites or legitimate ligands.

45. The data store of claim 40, wherein the information associated with each protein or drug molecule is provided to a data abstraction service and used to graphically present a protein or drug molecule in three dimensions.
